(19) United States
(12) Patent Application Publication
(10) Pub. No.: US 2021/0281696 A1
(43) Pub. Date: Sep. 9, 2021

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventors: Shigeru OKADA, Kanagawa (JP); Shusaku KUBO, Kanagawa (JP); Shintaro ADACHI, Kanagawa (JP); Kunihiko KOBAYASHI, Kanagawa (JP); Yusuke SUZUKI, Kanagawa (JP)

(73) Assignee: FUJIFILM Business Innovation Corp., Tokyo (JP)

(21) Appl. No.: 16/917,913

(22) Filed: Jul. 1, 2020

(30) Foreign Application Priority Data
Mar. 6, 2020 (JP) 2020-038999

(51) Int. Cl. H04N 1/00; H04N 1/48

(52) U.S. Cl. CPC H04N 1/00816; H04N 1/00806; H04N 1/48

(57) ABSTRACT

An information processing apparatus includes a processor. The processor is configured to acquire a first image read from a sheet with multiple first regions that include respectively writing locations of multiple choices that are unselected, acquire a second image read from a sheet with one of the choices selected and with information indicating that the one of the choices has been selected, the information being written at the writing location of the selected choice, output a selection result of the selected choice, the selection result determined in accordance with an arithmetic result of an arithmetic operation performed between a first value determined from the first region in the first image and a second value determined from a region in the second image corresponding to the first region, and exclude from the selection result the choice having the arithmetic result having a value equal to or above a specific value.

### CROSS-REFERENCE TO RELATED APPLICATIONS

This application is based on and claims priority under 35 USC 119 from Japanese Patent Application No. 2020-038999 filed Mar. 6, 2020.

### BACKGROUND

### (i) Technical Field

The present disclosure relates to an information processing apparatus and a non-transitory computer readable medium.

### (ii) Related Art

Image forming apparatuses automatically collecting questionnaires have been disclosed. For example, Japanese Patent 5146279 discloses such an image forming apparatus.

The image forming apparatus disclosed in Japanese Patent 5146279 adds a color additional writing region surrounding an answer region with a marker on a blank questionnaire sheet or sets a region circumscribing the color additional writing region to an answer region, and extracts an additional writing portion in response to a difference between an answered questionnaire sheet and the blank questionnaire sheet, and identifies the additional writing area as answer information in accordance with the set answer region.

If writing is performed on one of writing locations in multiple choices set on a sheet to select the writing location, the writing may be later struck out using a strikeout line. In such a case, the strikeout line may be possibly wrongly determined as being selected.

### SUMMARY

Aspects of non-limiting embodiments of the present disclosure relate to providing an information processing apparatus and a non-transitory computer readable medium to output a selection result of a choice at a higher accuracy level on a questionnaire sheet even with a strikeout line written thereon than when the strikeout line is not accounted for.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus. The information processing apparatus includes a processor. The processor is configured to acquire a first image read from a sheet with a plurality of first regions that include respectively writing locations of a plurality of choices that are unselected, acquire a second image read from a sheet with one of the choices selected and with information indicating that the one of the choices has been selected, the information being written at the writing location of the selected choice, output a selection result of the selected choice, the selection result determined in accordance with an arithmetic result of an arithmetic operation performed between a first value determined from the first region in the first image and a second value determined from a region in the second image corresponding to the first region, and exclude from the selection result the choice having the arithmetic result having a value equal to or above a specific value.

### BRIEF DESCRIPTION OF THE DRAWINGS

Exemplary embodiments of the present disclosure will be described in detail based on the following figures, wherein:

FIG. 1 is a block diagram illustrating an example of a control system of an image forming apparatus according to a first exemplary embodiment of the disclosure;

FIG. 2 illustrates an example of a collection table;

FIG. 3A illustrates an example of a service menu, FIG. 3B illustrates an example of a function setting screen, and FIG. 3C illustrates an example of an answer method setting screen;

FIG. 4 illustrates an example of a questionnaire collection guide screen;

FIG. 5A illustrates an example of a questionnaire sheet serving as page 1 having a first region written thereon, and FIGS. 5B through 5D illustrate an example of a major portion of a questionnaire sheet serving as page 1 having the first and second regions written thereon;

FIG. 6 illustrates an example of sheet feed order of questionnaire sheets when questionnaire sheets images are read from the questionnaire sheets;

FIG. 7 illustrates an example of an image of a setting questionnaire sheet;

FIG. 8A illustrates an example of a questionnaire sheet image subsequent to a dropout color operation and FIG. 8B illustrates a setting method of a writing region;

FIG. 9A illustrates an example of an image of an answered questionnaire sheet serving as page 2 and FIG. 9B illustrates an example of part of record contents of the collection table;

FIG. 10A illustrates an example of an image of an answered questionnaire sheet serving page 21 and FIG. 10B illustrates an example of part of the record contents of the collection table;

FIG. 11 illustrates an example of a collection result image;

FIG. 12 illustrates an example of a read result image;

FIG. 13 is a flowchart illustrating an example of a process of an image forming apparatus of a first exemplary embodiment;

FIG. 14 is a flowchart illustrating an example of the process of the image forming apparatus of the first exemplary embodiment;

FIG. 15 is a block diagram illustrating an example of a control system of an image forming apparatus of a second exemplary embodiment of the disclosure;

FIG. 16 illustrates an example of the collection table;

FIG. 17 illustrates an example of a questionnaire collection guide screen;

FIG. 18A illustrates an example of a setting questionnaire sheet as page 1 having the first region and second region written and FIG. 18B illustrates an example of a major portion of a setting questionnaire sheet as page 1 having the first region written thereon;

FIG. 19 illustrates an example of a sheet feed order of questionnaire sheets when questionnaire sheet images are read from the questionnaire sheets;

FIG. 20 illustrates an example of an image of a setting questionnaire sheet;

FIG. 21A illustrates an example of an answered questionnaire sheet image and FIG. 21B illustrates an example of part of record contents of the collection table;

FIG. 22A illustrates an example of a questionnaire sheet image and FIG. 22B illustrates an example of comma separated value (CSV) collection results;

FIG. 23 is a flowchart illustrating an example of a process of an image forming apparatus of the second exemplary embodiment;

FIG. 24 is a flowchart illustrating an example of the process of the image forming apparatus of the second exemplary embodiment;

FIG. 25 illustrates a first modification of the second exemplary embodiment; and

FIG. 26 illustrates a second modification of the first and second exemplary embodiments.

### DETAILED DESCRIPTION

Exemplary embodiments of the disclosure are described with reference to the drawings. Elements having a substantially identical function are designated with the same reference numeral and the discussion thereof is not duplicated. An image forming apparatus is described below as an example of an information processing apparatus.

An image forming apparatus of an exemplary embodiment includes a processor. The processor is configured to acquire a first image read from a sheet having multiple first regions that includes respectively writing locations of multiple choices that are unselected, acquire a second image read from a sheet having one of the choices selected and having information indicating the selection of the choice at the writing location of the selected choice, output a selection result of the choice, the selection result determined in accordance with an arithmetic result of an arithmetic operation performed between a first value determined from the first region in the first image and a second value determined from a region in the second image corresponding to the first region and exclude from the selection result the choice having the arithmetic result having a value equal to or above a specific value.

A writing location indicates a location where information indicating that selection has been done is written. For example, the writing location is a check box, a number, or the like. If the writing location is a check box, the information indicating that the selection has been down is a check mark, and if the writing location is a number, the information indicating that the selection has been done is a circle surrounding the number.

For example, the first region may have a rectangular, circular, elliptical, or linear shape. The sheet may be a questionnaire sheet, an answer sheet, or a problem sheet.

The first value may be the number of black points within the first region (excluding a linear shape), the number of black points within a writing region circumscribing the first region, or the number of black points within a writing region inscribing the first region. The second value may be the number of black points within a region corresponding to the first region, the number of black points within a region corresponding to the writing region circumscribing the first region, or the number of black points within a region corresponding to the writing region inscribing the first region. If the information indicating that the selection has been done is written in the writing region, the second value becomes larger than the first value and if the information is canceled by a strikeout line, the second value become even more larger.

If the information indicating that the selection has been done is written at the writing location and the information is then canceled by the strikeout line, an arithmetic result of an arithmetic operation performed between the first value and the second value may typically exceed a specific value. The choice causing the arithmetic result to exceed the specific value in response to the cancellation by the strikeout line may be excluded from the selection results.

### First Exemplary Embodiment

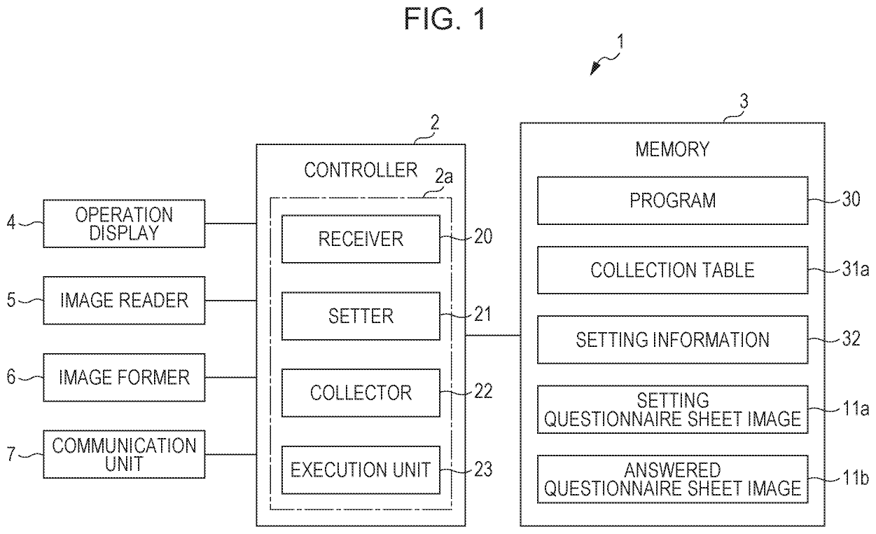

FIG. 1 is a block diagram illustrating an example of a control system of an image forming apparatus 1 according to a first exemplary embodiment of the disclosure. The image forming apparatus 1 is a multi-function apparatus having multiple functions including one or more of functions of scanning, printing, copying, emailing, and faxing. The image forming apparatus 1 has a function of setting a writing region using a dropout color operation. The function of setting the writing region is performed when a collection process is performed on answered questionnaires. The dropout color operation refers to an operation to delete a specific color (for example, red) from an image. A questionnaire sheet is an example of a paper sheet.

The image forming apparatus 1 includes a controller 2. The controller 2 is connected to a memory 3, operation display 4, image reader 5, image former 6, communication unit 7, and the like.

The controller 2 includes a processor 2a, such as a central processing unit (CPU), and an interface. By executing a program 30, the processor 2a functions as a receiver 7, receiver 20, setter 21, collector 22, execution unit 23, and the like. The receiver 20 through the execution unit 23 are described in detail below.

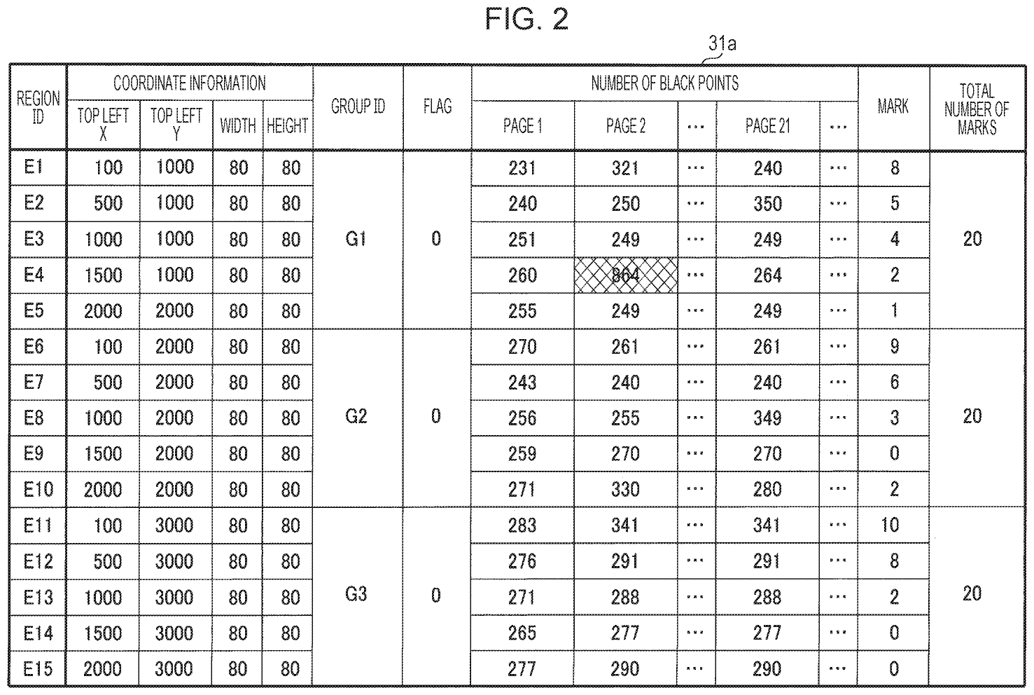

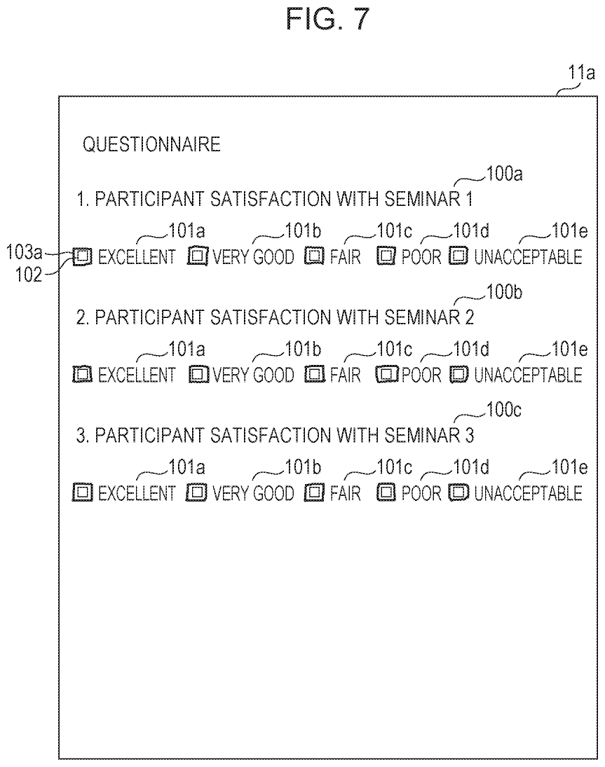

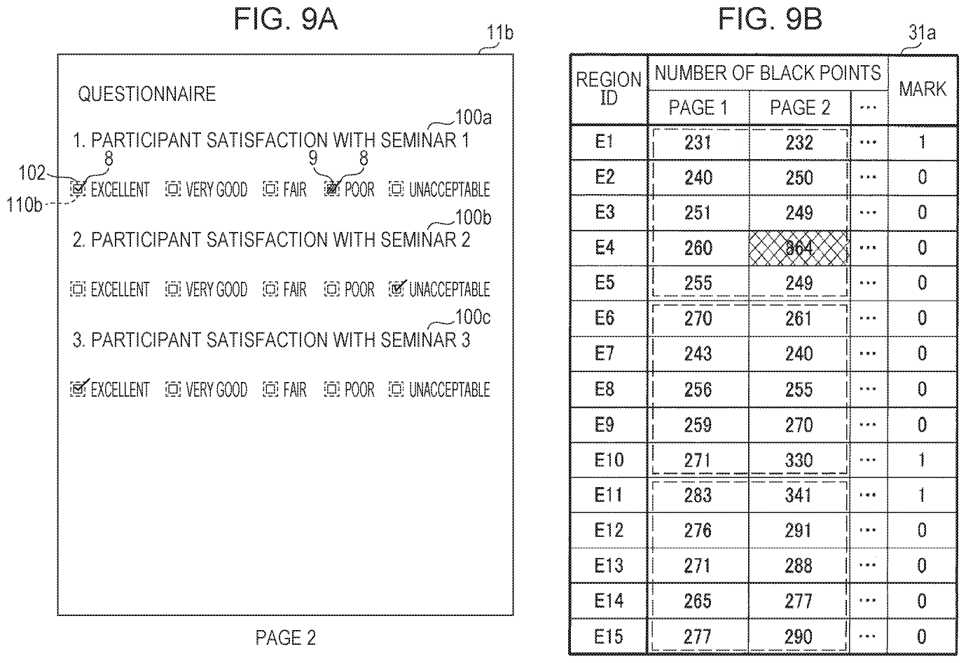

The memory 3 may include a read-only memory (ROM), random-access memory (RAM), hard disk, and the like. The memory 3 stores a variety of information including a program 30, collection table 31a (see FIG. 2), setting information 32, setting questionnaire sheet image 11a (see FIG. 7), and answered questionnaire sheet image 11b (see FIG. 9).

The operation display 4 is used to receive and display information. For example, the operation display 4 is a touch panel display and includes a liquid-crystal display and a touch panel overlaid on the liquid-crystal display.

The image reader 5 includes an automatic sheet feeder arranged on a document platen and a scanner that optically reads a document image of an original document placed on the document platen, or an original document or a questionnaire sheet transported by the automatic document feeder.

The image former 6 produces printed matter by forming an image on a sheet transported from a paper cassette via electrophotographic method or ink-jet method.

The communication unit 7 communicates with an external apparatus, such as a user terminal or server, via a network such as, a local area network (LAN) and/or the Internet.

FIG. 2 illustrates an example of the collection table 31a. The collection table 31a includes multiple entry columns for a region identification (ID), coordinate information, group ID, flag, number of black points, mark, total number of marks. The flag is an example of identification information.

The region ID identifies a first region 103a, writing region 110a, or region 110b corresponding to the writing region 110a. The coordinate information includes coordinates of a top left corner of the writing region 110a (top left X representing X coordinate and top left Y representing Y coordinate), width, and height. The region 110b corresponding to the writing region 110a has the same coordinate information as the writing region 110a. The values for the coordinate information are quoted for convenience only and are thus different from actual values. The group ID identifies questions (hereinafter also referred to as a group) to which the writing region 110a or the region 110b corresponding to the writing region 110a belongs. The flag has a default value of 0. If the group is multi-answer permitted, the flag is 1. The number of black points is the number of black points within the writing region 110a or the region 110b corresponding to the writing region 110a. If the collector 22 determines that selection is made from within one group on a per page basis, 1 is added to the corresponding mark cell. The question or a group is an example of a set.

The receiver 20 through the execution unit 23 in the controller 2 are described below.

The receiver 20 receives a job instructed by an operation performed on the operation display 4, a print job transmitted from an external apparatus via a network, or a fax print job from an external apparatus via a public network line.

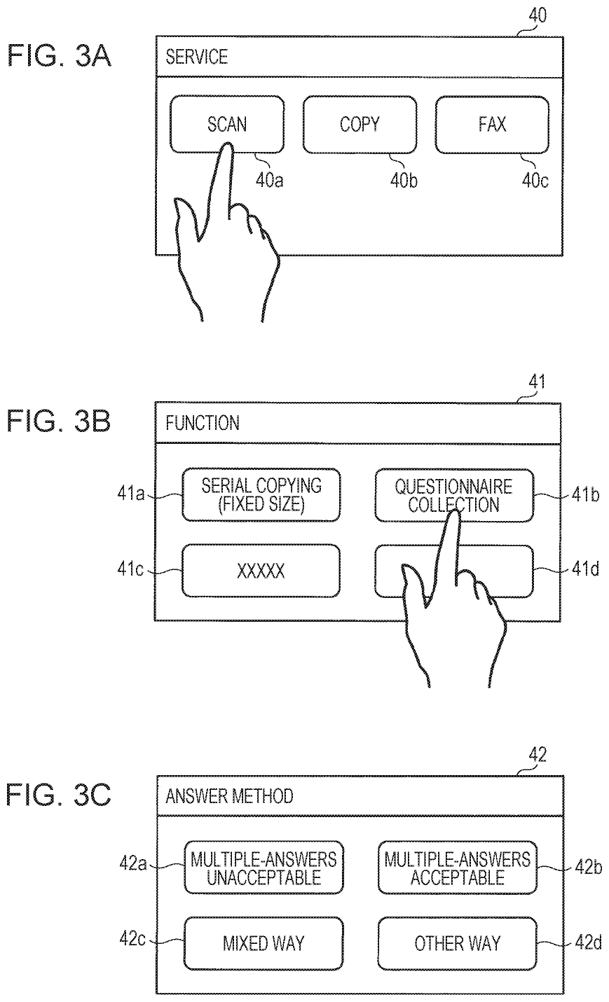

The setter 21 displays on the operation display 4 a variety of screens including a service menu screen 40 (see FIG. 3A), function setting screen 41 (see FIG. 3B), answer method setting screen 42 (see FIG. 3C). The setter 21 also stores on the memory 3 setting information 32 about a selected answer method or the like.

The collector 22 sets the writing region 110a having a rectangular shape circumscribing the first region 103a that is written in a first color (such as red) and surrounds a check box 102 in the setting questionnaire sheet image 11a.

The collector 22 determines as a first value the number of black points within each writing region 110a in the setting questionnaire sheet image 11a, determines as a second value the number of black points within the region 110b corresponding to each writing region 110a in the answered questionnaire sheet image 11b, and calculates a ratio of the second value to the first value (second value/first value). The setting questionnaire sheet image 11a is an example of a first image. The answered questionnaire sheet image 11b is an example of a second image.

If the question is multiple-answers unacceptable, the collector 22 outputs as a selection result a choice having the largest ratio of the second value to the first value (second value/first value), the choice excluding the ratio exceeding a second threshold). If the question is multiple-answers acceptable, the setter 21 outputs as a selection result a choice having the ratio of the second value to the first value being equal to or above a first threshold (for example, 1.5) above and equal to or below a second threshold (for example, 2.5).

A second region 104 may be written in a second color that is the same color as the first regions 103a such that the second region 104 includes multiple first regions 103a forming the same group of questions. The collector 22 performs collection, based on the assumption that the first regions 103a in the second region 104 form the same group. A second region 105 is written in a second color (for example, blue) different from the color of the first region 103a such that the second region 105 includes multiple first regions 103a forming the same group of questions. In that case, the collector 22 records, on the flag of the collection table 31a, a flag of 1 indicating that the group is multiple-answers acceptable. A flag of 0 indicates that the group is multiple-answers unacceptable.

The execution unit 23 performs a job received by the receiver 20 by controlling the image reader 5, image former 6 and/or communication unit 7.

Example of a process of the image forming apparatus 1 is described below.

How to set an answer method is described with reference to FIG. 3.

The setter 21 displays a service menu screen 40 on the operation display 4 in response to a user request.

FIG. 3A illustrates an example of the service menu screen 40. The service menu screen 40 includes a “scan” button 40a to select a scan function, a “copy” button 40b to select a copy function, and a “fax” button 40c to select a fax function. For example, a user may now select the scan function by operating the scan button 40a.

The setter 21 displays on the operation display 4 a function setting screen 41 to select a subfunction belonging to the scan function.

FIG. 3B illustrates a function setting screen 41. The function setting screen 41 includes a “serial page copying (fixed size)” button 41a to select a serial page copying function, a “questionnaire collection” button 41b to select a questionnaire collection function, and other buttons 41c and 41d.

The page serial copying is one of reading methods to read an original document and is used to copy the original document in a manner such that one page is separated from the subsequent page of a two-page spread form. The questionnaire collection extracts answer results from questionnaire sheets and collects the answer results as selection results. The user may then operate the questionnaire collection button 41b. The setter 21 displays an answer method setting screen 42 on the operation display 4.

FIG. 3C illustrates an example of the answer method setting screen 42. The answer method setting screen 42 is used to set the answer method of questionnaire sheets. The answer method setting screen 42 includes a “multiple-answers unacceptable” button 42a, a “multiple-answers acceptable” button 42b, a “mixed way” button 42c, and “other” button 42d.

The multiple-answers unacceptable button 42a is used to set all the questions to multiple-answers unacceptable. The multiple-answers acceptable button 42b is used to set all the questions to multiple-answers acceptable. The mixed way button 42c is used to set a mixed way in which a multiple-answers unacceptable question and a multiple-answers acceptable question are mixed. The user may now select the multiple-answers unacceptable button 42a.

The setter 21 stores the selected answer method as the setting information 32 on the memory 3.

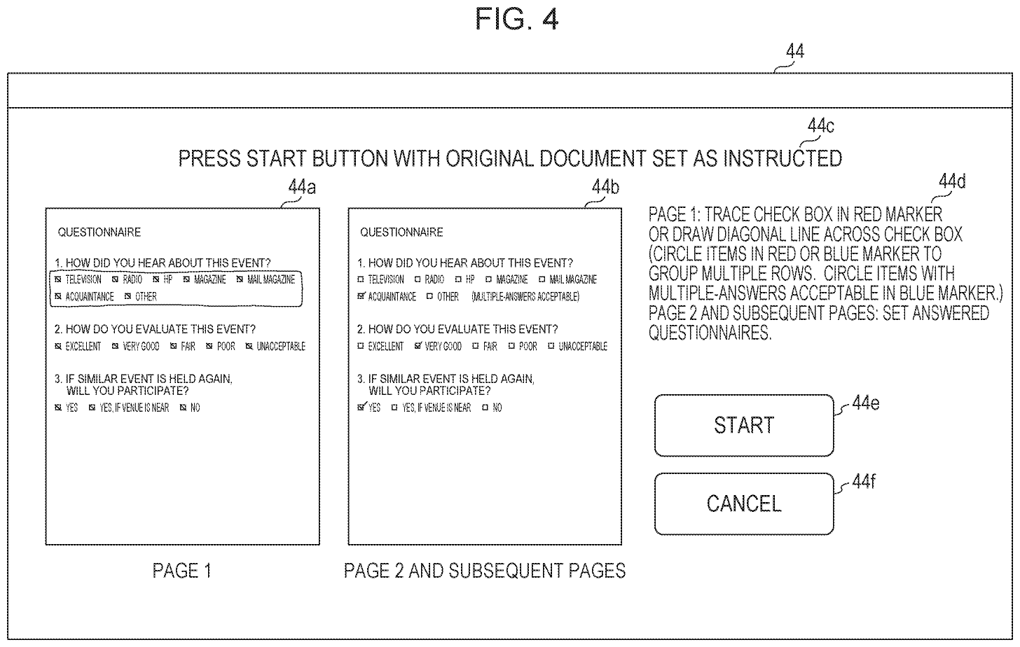

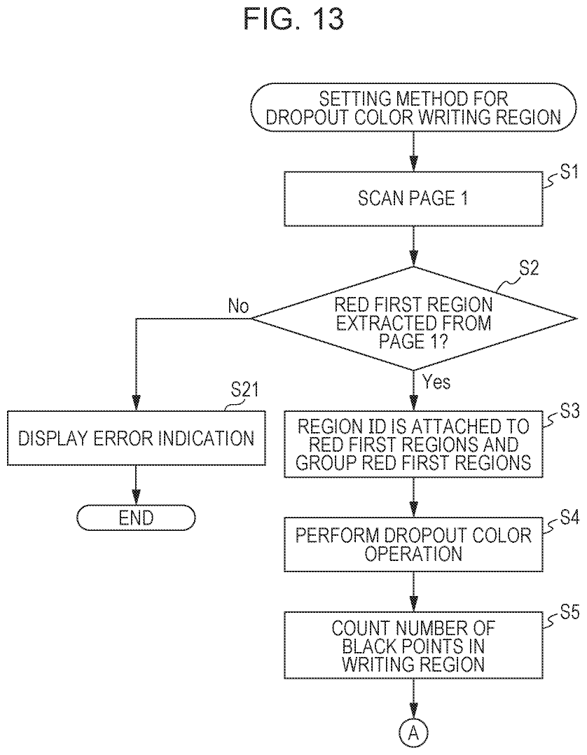

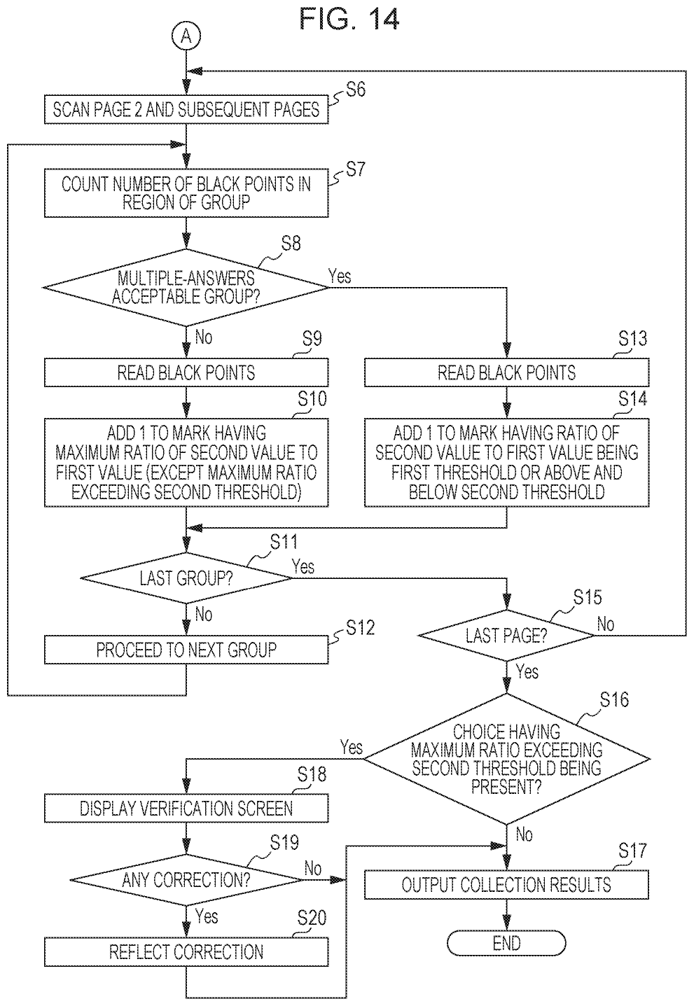

Example of a collection process of the image forming apparatus 1 is described with reference to FIGS. 4 through 14. FIGS. 13 and 14 illustrate examples of the process of the image forming apparatus 1.

When the answer method is selected on the answer method setting screen 42, the collector 22 displays a questionnaire collection guide screen 44 on the operation display 4.

FIG. 4 illustrates an example of the questionnaire collection guide screen 44. The questionnaire collection guide screen 44 includes questionnaire sample images 44a and 44b, message 44c, note 44d, “start” button 44e, and “cancel” button 44f. The questionnaire sample image 44a indicates that page 1 is a questionnaire sheet 10a. The questionnaire sample image 44b indicates that page 2 and subsequent pages are answered questionnaires 10b. The message 44c explains the operation procedure. The note 44d explains the operation to be applied to pages 1 and 2, and subsequent pages. The start button 44e is used to start the questionnaire collection function. The cancel button 44f is used to cancel the selection of the questionnaire collection function.

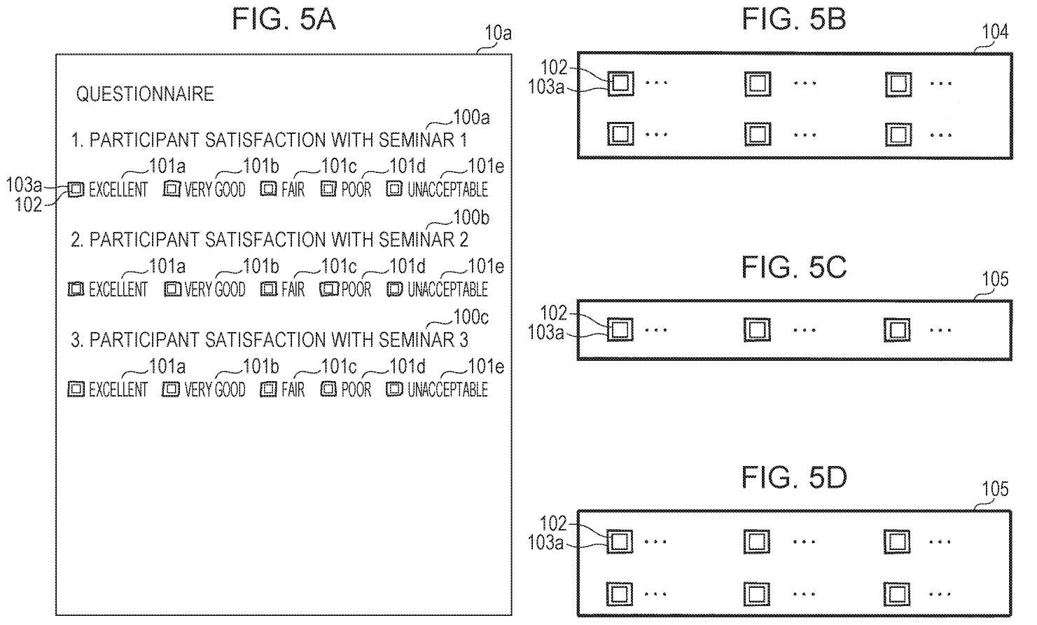

FIG. 5A illustrates an example of the questionnaire sheet 10a on which page 1 having the first region written thereon is set. FIGS. 5B through 5D illustrate examples of major portions of the setting questionnaire sheet 10a on which page 1 having the first and second regions written thereon is set.

Referring to FIG. 5A, the questionnaire sheet 10a includes multiple questions, for example, three questions 100a through 100c (collectively referred to as question 100). Each of the questions 100a through 100c is associated with multiple answer choices, for example, five choices 101a through 101e (collectively referred to as “choices 101”) and check boxes 102 used to respectively select the choices 101. In the questionnaire sheet 10a, the rectangular first region 103a is written in a first color marker (for example, a red color marker), surrounding the check box 102. The check box 102 is an example of a writing location.

In the questionnaire sheet 10a in FIG. 5A, choices 101 to each question 100 are horizontally arranged in a row but may be also arranged vertically across multiple rows. In the questionnaire sheet 10a in FIG. 5A, each question 100 is multiple-answers unacceptable, but may be multi answers acceptable, or may be in a mixed way with multiple-answers unacceptable and multiple-answers acceptable.

If choices 101 are arranged vertically across multiple rows in response to a single question 100, or the question 100 extending along one row and the question 100 extending vertically across multiple rows coexist, the collector 22 may have difficulty in determining what choices 101 correspond to a given single 100 in accordance with the pitch between lines. The choices 101 to the question 100 may be vertically arranged across multiple rows as illustrated in FIG. 5B. The second region 104 is written in the first color marker (for example, red) that is the same color as the first region 103a in order to indicate the choices 101 form the same group. The first color of the second region 104 is used to indicate that the choices 101 surrounded by the second region 104 form the same group.

The question 100 may be multiple-answers acceptable. If a note “multiple-answers acceptable” is written in the questionnaire sheet 10a, the collector 22 may have difficulty in determining a multiple-answers acceptable status, depending on the character size of the note and character recognition accuracy of the note. As illustrated in FIG. 5C, in the multiple-answers acceptable question 100, a second region 105 is written in a second color (for example, blue) marker different from the color of the first region 103a.

If the choices 101 to the question 100 vertically extends across multiple rows and the question 100 is multiple-answers acceptable, the second region 105 is written in a second color (for example, blue) different from the color of the first regions 103a such that the first regions 103a extending across multiple rows are surrounded as illustrated in FIG. 5D.

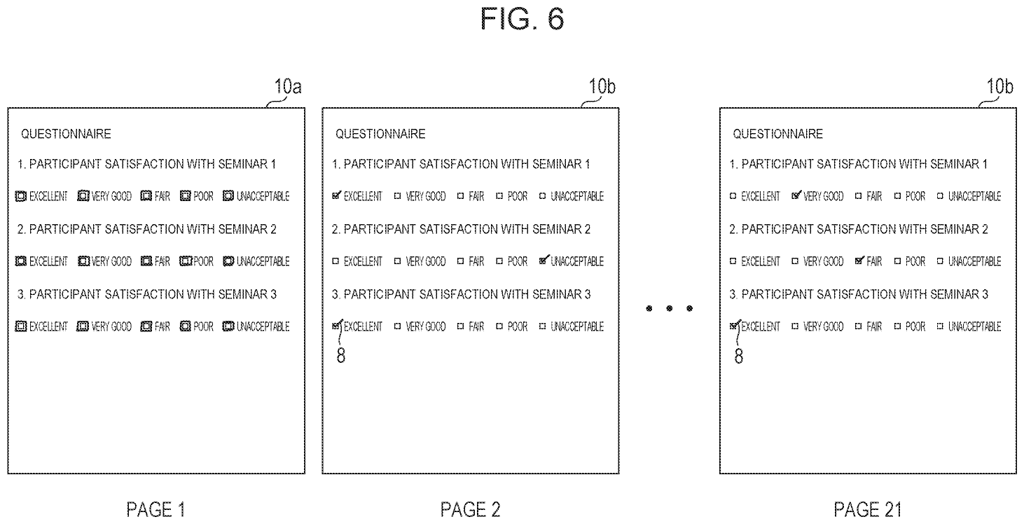

FIG. 6 illustrates an example of paper sheet order of questionnaire sheets when the questionnaire sheet images are read from questionnaire sheets. When the questionnaire sheet 10a as page 1 is ready, the user refers to guide information on the questionnaire collection guide screen 44 and stacks the questionnaire sheets 10a and 10b in a manner such that the setting questionnaire sheet 10a becomes page 1 and the answered questionnaire sheet 10b becomes page 2 as illustrated in FIG. 6 and sets the stack of the questionnaire sheet 10a and 10b on an automatic sheet feeder in the image reader 5.

The user operates the start button 44e on the questionnaire collection guide screen 44 in FIG. 4. The automatic sheet feeder in the image reader 5 successively feeds the set questionnaire sheets 10a and 10b to a read position, starting with page 1.

### (i) Process on Page 1

A scanner in the image reader 5 reads the setting questionnaire sheet image 11a as illustrated in FIG. 7 from the questionnaire sheet 10a as page 1 fed to the read position by the automatic sheet feeder (S1). The image reader 5 stores the setting questionnaire sheet image 11a on the memory 3.

The collector 22 detects the red color from the setting questionnaire sheet image 11a to determine whether the first region 103a is extracted. If the first region 103a is not detected because the red marker line is thin or broken (no path from S2), the operation display 4 displays an error indication (S21).

If the first region 103a is detected (yes path from S2, the collector 22 attaches a region identification (ID) to the first region 103a and groups the first region 103a (S3).

The collector 22 attaches regions IDs E1 through E15 respectively to the extracted first regions 103a and records the region IDs in the region ID column in the collection table 31a.

Since the questionnaire sheet image 11a does not include the second region 104, the collector 22 attaches the same group IDs G1 through G3 to the choices 101 arranged in respective rows and records the group IDs in the group ID column in the collection table 31a.

The collector 22 performs a dropout color operation on the questionnaire sheet image 11a (S4).

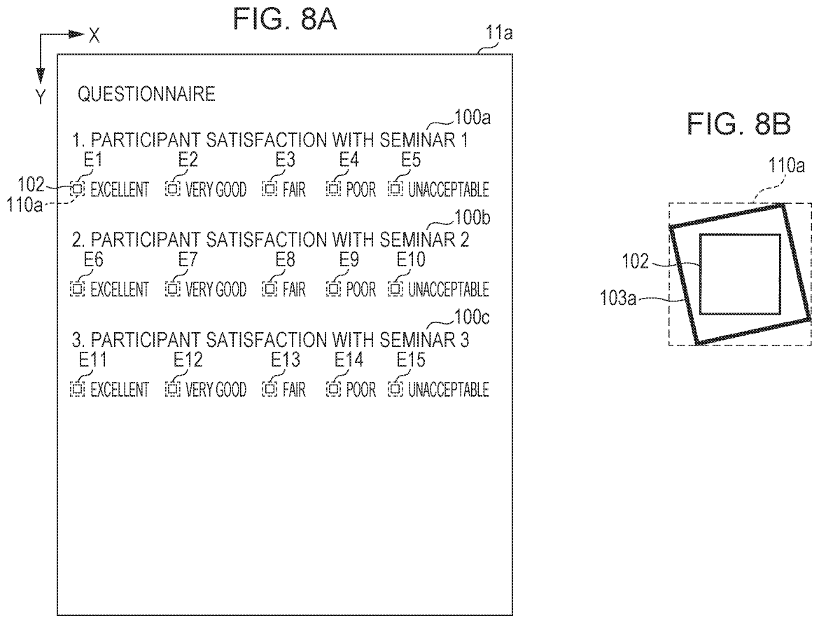

FIG. 8A illustrates an example of the questionnaire sheet image 11a subsequent to the dropout color operation and FIG. 8B illustrates a setting method of a writing region.

Referring to FIG. 8B, the collector 22 sets the writing region 110a having a rectangular shape circumscribing the first region 103a that is written in a red marker and surrounds the check box 102. The red first region 103a is deleted through the dropout color operation.

The collector 22 extracts coordinates of the writing region 110a, determines the top left corner coordinates (X, Y) of the writing region 110a, calculates the width and height of the writing region 110a, and records these pieces of data on the corresponding columns in the collection table 31a.

The collector 22 counts the black points within the writing region 110a in the questionnaire sheet image 11a as page 1 to determine the number of black points and records the number of black points at the number of black points column on page 1 in the collection table 31a as illustrated in FIG. 2B (S5).

### (ii) Process on Page 2 and Subsequent Pages

The scanner in the image reader 5 reads the answered questionnaire sheet image 11b from the answered questionnaire sheet 10b as page 2 transported to the read position by the automatic sheet feeder as illustrated in FIG. 9A (S6). The image reader 5 stores the answered questionnaire sheet image 11b on the memory 3. In the answered questionnaire sheet image 11b in FIG. 9A, a check mark 8 is written in the check box 102. The check mark 8 is written in the fourth check box 102 in the first question 100a but is then later canceled by a strikeout line 9. The check mark 8 is an example of information that indicates that the selection has been made.

The collector 22 sets the region 110b corresponding to the writing region 110a in the answered questionnaire sheet image 11b as page 2, counts the black points within the region 110b to determine the number of black points, and records the number of black points at the number of black points column on page 2 in the collection table 31a as illustrated in FIGS. 2 and 9B (S7).

The collector 22 determines whether the group having the group ID G1 is multiple-answers acceptable (S8).

The collector 22 determines in accordance with the multiple-answers unacceptable setting information 32 that the group G1 is not multiple-answers acceptable (no path from S8), reads as the first value the number of black points on page 1 and the number of black points on page 2, each having the group ID G1 from the collection table 31a (S9), calculates the ratio of the second value to the first value (second value/first value), and determines as an answer the region ID having the highest ratio of the second value to the first value from among the group ID G1 (the ratio of the second value to the first value exceeding the second threshold is excluded). The collector 22 adds 1 to the corresponding mark cell in the collection table 31a (S10).

Referring to FIG. 9A, the number of black points exceeds the second threshold in the region ID E4 and the check mark 8 is thus canceled with the strikeout line. The collector 22 adds color to the cell corresponding to the region ID E4.

If the multiple-answers acceptable button 42b is selected in the answer method setting screen 42 in FIG. 3C, the collector 22 determines in accordance with the multiple-answers acceptable setting information 32 that the group G1 is multiple-answers acceptable (yes path from S8). From the collection table 31a, the collector 22 reads as the first value the number of black points on page 1 and as the second value the number of black points on page 2 of the group ID G1 (S13), calculates the ratio of the second value to the first value, determines as an answer a ratio of the second value to the first value equal to or above the first threshold and equal to or below the second value, and adds 1 to the corresponding mark cell in the collection table 31a (S14).

If the mixed way button 42c is selected in the answer method setting screen 42 in FIG. 3C, the collector 22 determines in accordance with the value at the flag column in the collection table 31a whether the G1 group is multiple-answers unacceptable (no path from S8) or multiple-answers acceptable (yes path from S8).

The collector 22 determines whether the present group is the last group (S11). If the present group is not the last group (no path from S11), the collector 22 proceeds to the next group (S12) and then repeats operations in S7 through S14.

Referring to FIGS. 2 and 9B, 1 is added to a region ID E1 in a group ID G1, 1 is added to a region ID E10 in a group ID G2, and 1 is added to a region ID E11 in a group ID G3.

If the present group is the last group (yes path from S11), the collector 22 determines whether the present page is the last group (S15).

Since the present page is page 2 and not the last group (no path from S15), the collector 22 proceeds to step S6 and performs the process performed on page 2 on page 3 and subsequent pages.

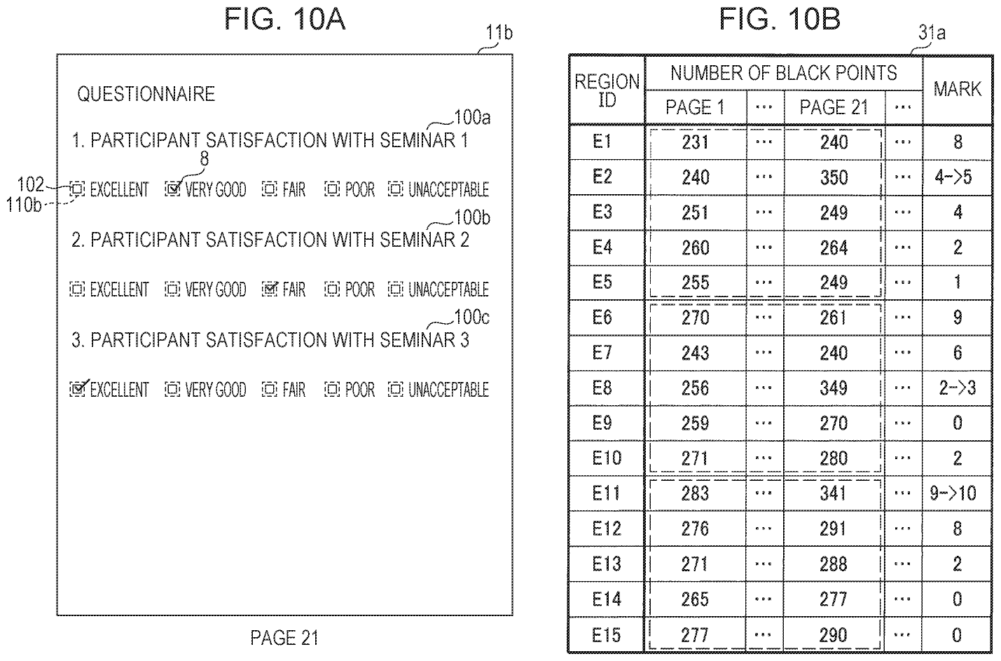

The collector 22 sets the region 110b corresponding to the writing region 110a in the answered questionnaire sheet image 11b serving as page 21 which is the last page. The collector 22 counts the black points within the region 110b to determine the number of black points, and records the number of black points on the number of black points column in the collection table 31a as illustrated in FIGS. 2 and 10B (S7).

From the collection table 31a, the collector 22 reads as the first value the number of black points on page 1 and as the second value the number of black points on page 2 in the group ID G1 (S9), calculates the ratio of the second value to the first value, determines as an answer the highest ratio of the second value to the first value in the group ID G1 (excluding the ratio of the second value to the first value exceeding the second threshold), and adds 1 to the corresponding mark cell in the collection table 31a (S10).

The collector 22 determines whether the present group is the last group (S11). If the present group is not the last group (no path from S11), the collector 22 proceeds to the next group (S12) and repeats operations in S7 through S10, S13 and S14.

Referring to FIGS. 2 and 10B, 1 is added to the region ID E2 in the group ID G1, causing the value at the corresponding mark cell to change from 4 to 5. In the group ID G2, 1 is added to the region ID E8, causing the value at the mark cell to change from 2 to 3 and in the group ID G3, 1 is added to the region ID E11, causing the value at the mark cell to change from 9 to 10.

If the present page is the last page (yes path from S15), the collector 22 sums the values in the mark cells on a per group basis, records in the total number of marks column in the collection table 31a, and checks that the total number of marks equals the number of scans −1.

The collector 22 determines whether a choice having an outlier value with the ratio of the second value to the first value exceeding the second threshold (S16) has been found. If there is such a choice (yes path from S16), the collector 22 displays a verification screen on the operation display 4 (S18).

The verification screen displays a message reading “Are you sure you want to cancel the following choices?” and a message reading “Please correct if necessary”. If the selection is to be corrected (yes path from S19), the correction is reflected in the collection table 31a (S20).

In the answered questionnaire sheet image 11b as page 2, the number of black points within the region ID E4 in the group ID G1 is an outlier value of 864 and thus the ratio of the second value to the first value exceeds the second threshold. In such a case, the collector 22 displays the verification screen for the choices on the operation display 4.

In succession to steps S19 and S20, or no path from S16, the collector 22 generates and outputs a collection result image 12 indicating collection results and a read result image 13 indicating answer read results (S17). Verification and correction in steps S16, and S18 through S20 may be performed after outputting the collection result image 12 and read result image 13.

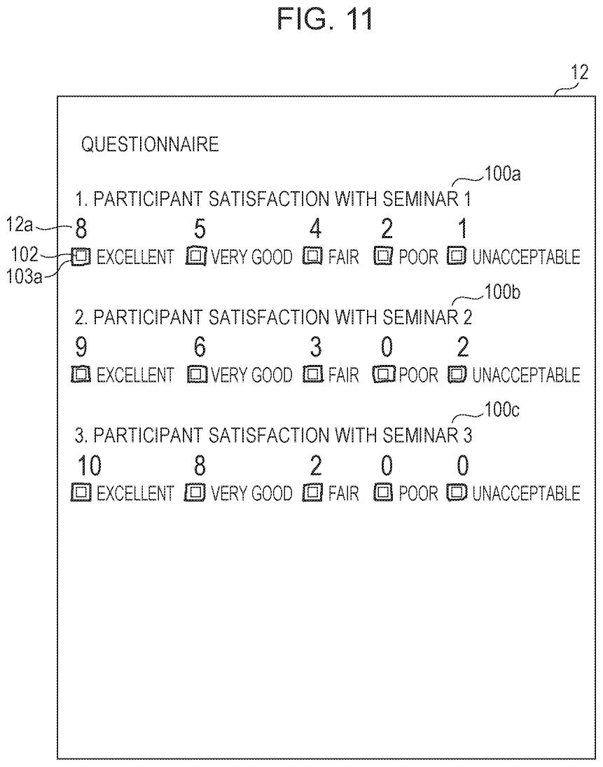

FIG. 11 illustrates an example of the collection result image 12. The collection result image 12 is generated in portable document format (PDF) by adding mark values 12a at the mark column in the collection table 31a respectively to the choices at each question in the questionnaire sheet image 11a read from the setting questionnaire sheet 10a. The user may recognize the contents of the choices with the mark values 12a from the collection result image 12. The mark values 12a may be output in comma separated value (CSV).

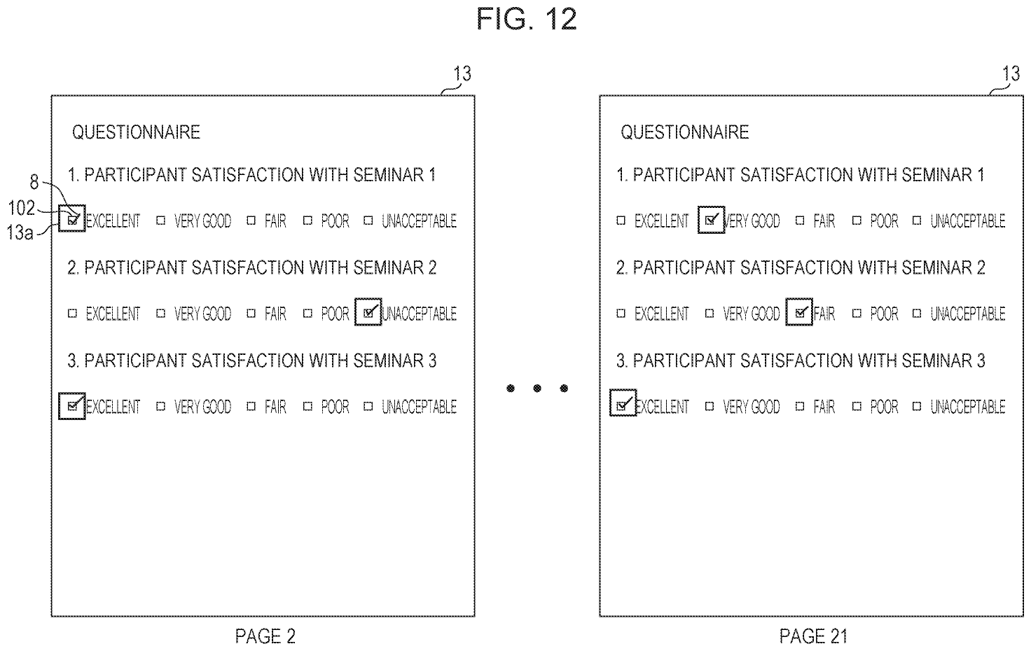

FIG. 12 illustrates an example of the read result image 13. The read result image 13 is generated in PDF by adding a rectangle 13a to a check box 102 indicating selection results in the answered questionnaire sheet image 11b read from the answered questionnaire sheet 10b. The user may recognize from the read result image 13 the selection results determined on the image forming apparatus 1.

### Second Exemplary Embodiment

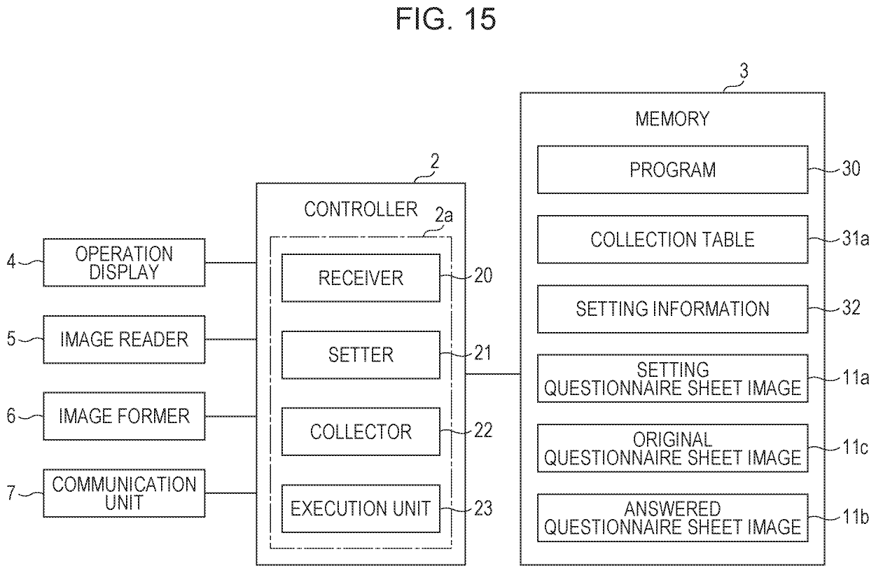

FIG. 15 is a block diagram illustrating an example of a control system of the image forming apparatus 1 of a second exemplary embodiment of the disclosure. In the first exemplary embodiment, the writing region is set up using the dropout color operation. In the second exemplary embodiment, the writing region is set up by using a difference process between the setting questionnaire sheet image and an original questionnaire sheet image. The following discussion focuses on a difference between the first and second exemplary embodiments.

As in the first exemplary embodiment, the controller 2 includes the processor 2a, interface, and the like. In a way similar to the first exemplary embodiment, the processor 2a executes the program 30 stored on the memory 3, thereby functioning as the receiver 20, setter 21, collector 22, execution unit 23, and the like.

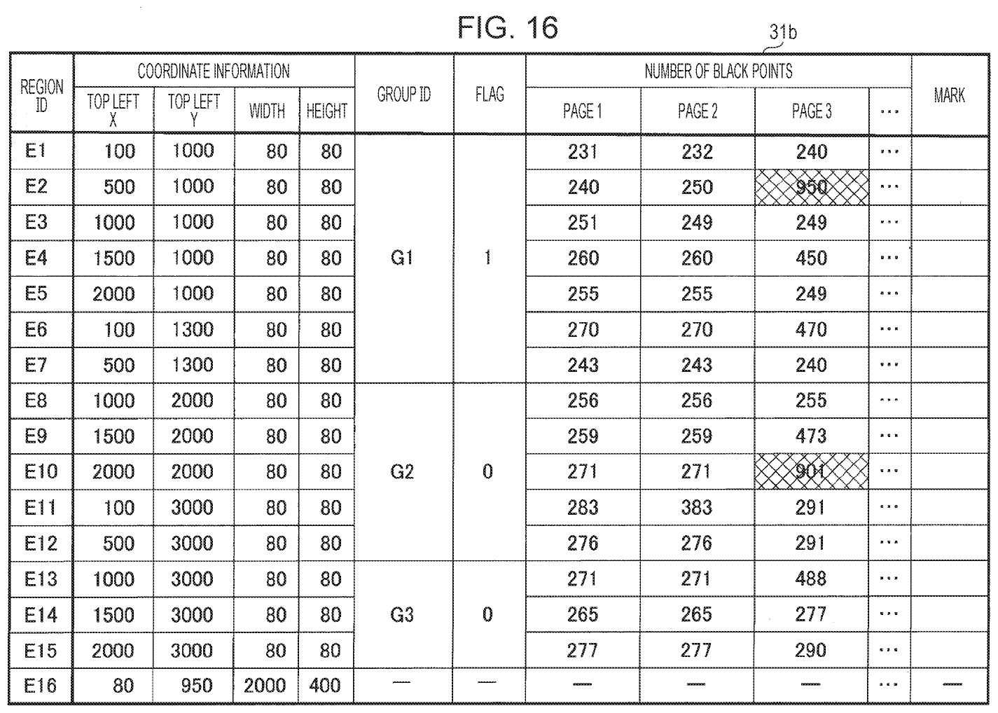

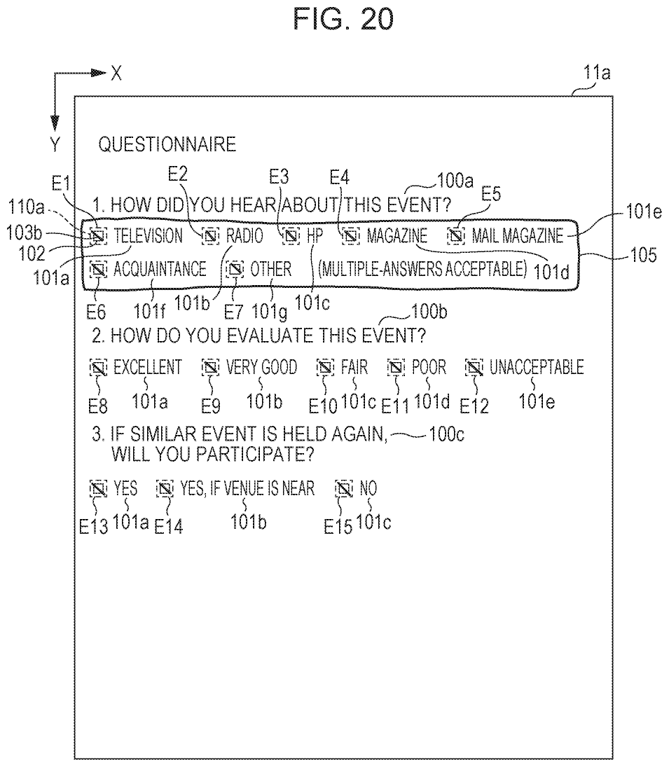

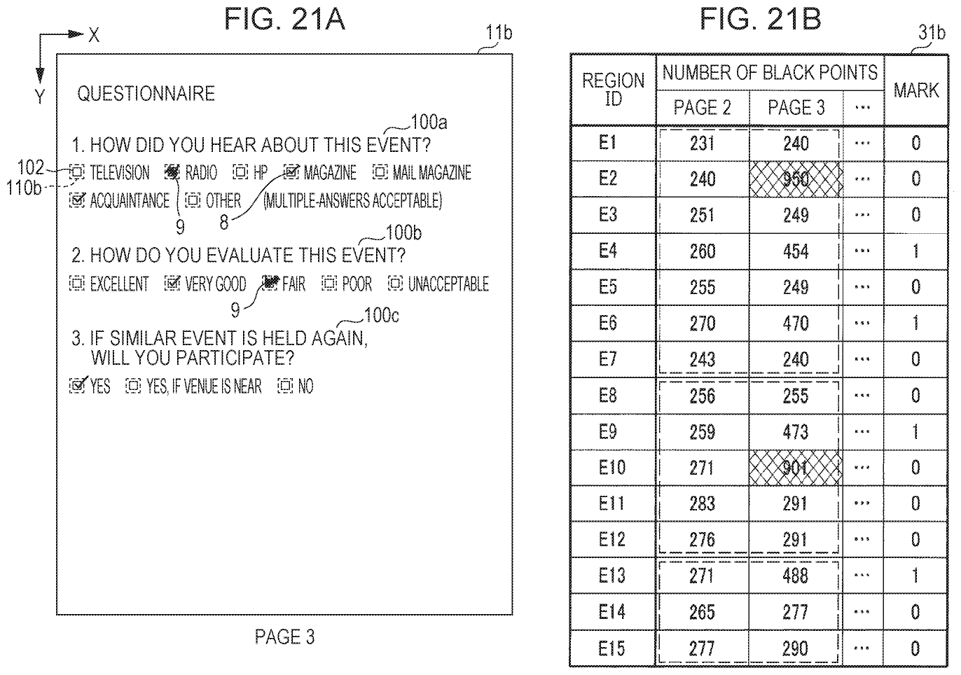

In a way similar to the first exemplary embodiment, the memory 3 stores a variety of information including the program 30, collection table 31b (see FIG. 16), setting information 32, setting questionnaire sheet image 11a (see FIG. 20), answered questionnaire sheet image 11b (see FIG. 21A), and original questionnaire sheet image 11c. The original questionnaire sheet image 11c is an example of a third image.

FIG. 16 illustrates an example of the collection table 31b. The collection table 31b includes multiple columns for the region ID, coordinate information, flag, number of black points, and mark, but does not include the column for the total number of marks. The values of the coordinate information are quoted for convenience of explanation and actual values are different from those values.

The process of the image forming apparatus 1 is described below.

The setting of the answer method remains unchanged from that of the first exemplary embodiment and the discussion thereof is not repeated. The mixed way button 42c may now be selected in the answer method setting screen 42 in FIG. 3C.

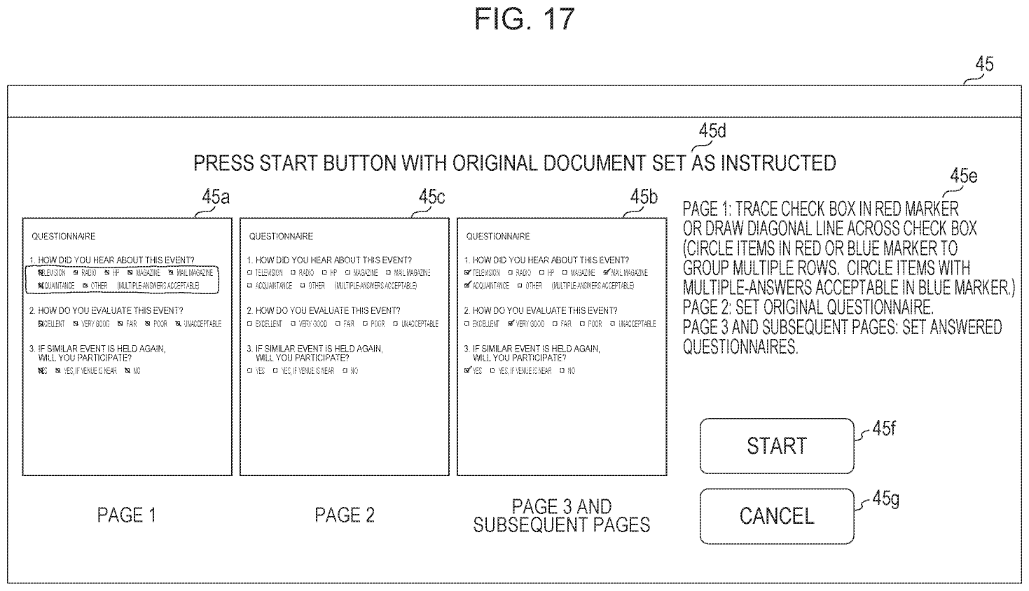

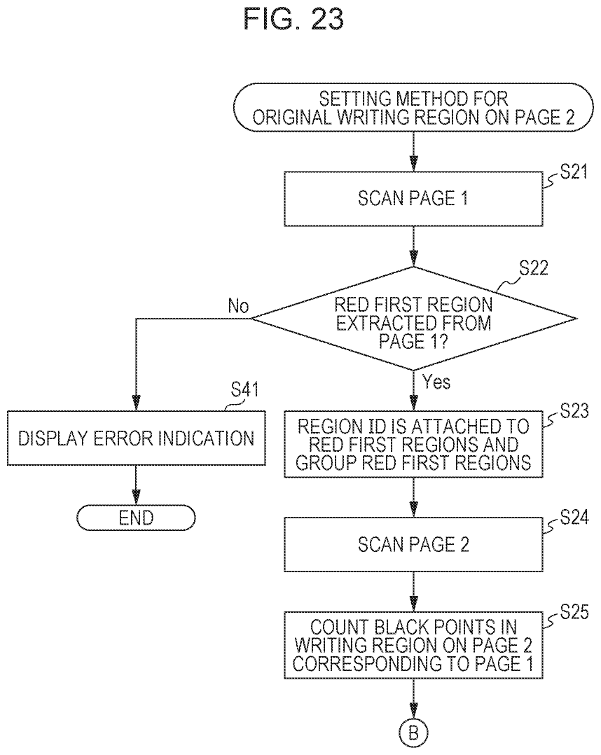

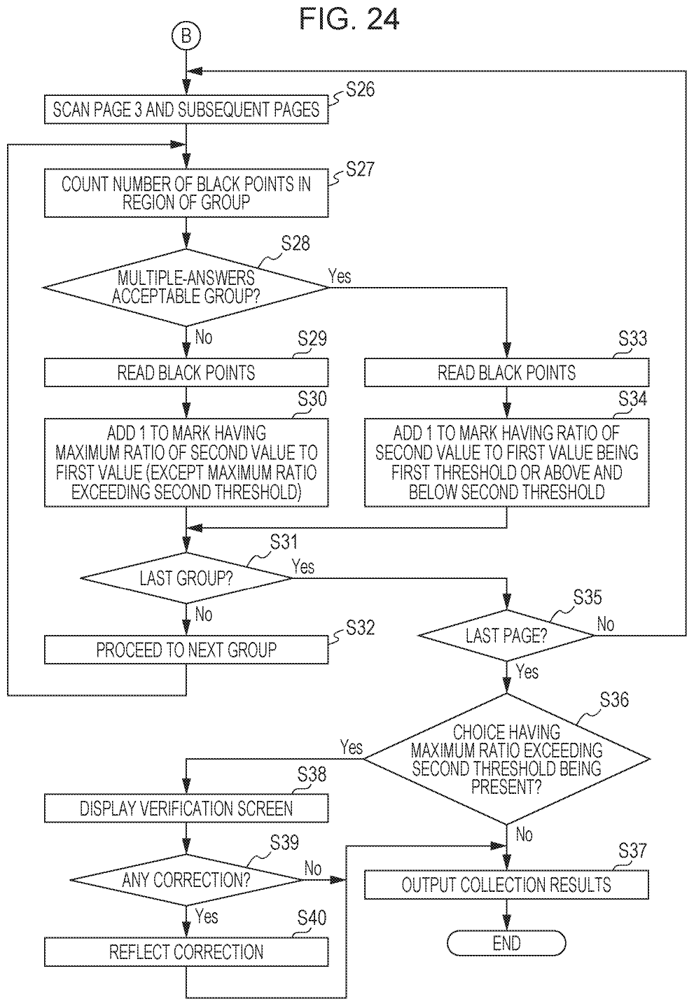

The process of the image forming apparatus 1 is described with reference to FIGS. 17 through 24. FIGS. 23 and 24 illustrate flowcharts of the process of the image forming apparatus 1.

If the answer method is selected in the answer method setting screen 42 as described with reference to the first exemplary embodiment, the collector 22 displays a questionnaire collection guide screen 45 on the operation display 4.

FIG. 17 illustrates an example of the questionnaire collection guide screen 45. The questionnaire collection guide screen 45 includes questionnaire sample images 45a, 45b, and 45c, message 45d, note 45e, start button 45f, and cancel button 45g. The questionnaire sample image 45a indicates that page 1 is a setting questionnaire sheet 10a. The questionnaire sample image 45c indicates that page 2 is an original questionnaire sheet 10c. The questionnaire sample image 45b indicates that page 3 and subsequent pages are answered questionnaire sheets 10b. The message 45d explains the operation procedure. The note 45e explains the operation to be applied to page 1, page 2, and page 3 and subsequent pages. The start button 45f is used to start the questionnaire collection function. The cancel button 45g is used to cancel the selection of the questionnaire collection function. The original questionnaire sheet is an unanswered questionnaire sheet with the first regions 103a and 103b unwritten.

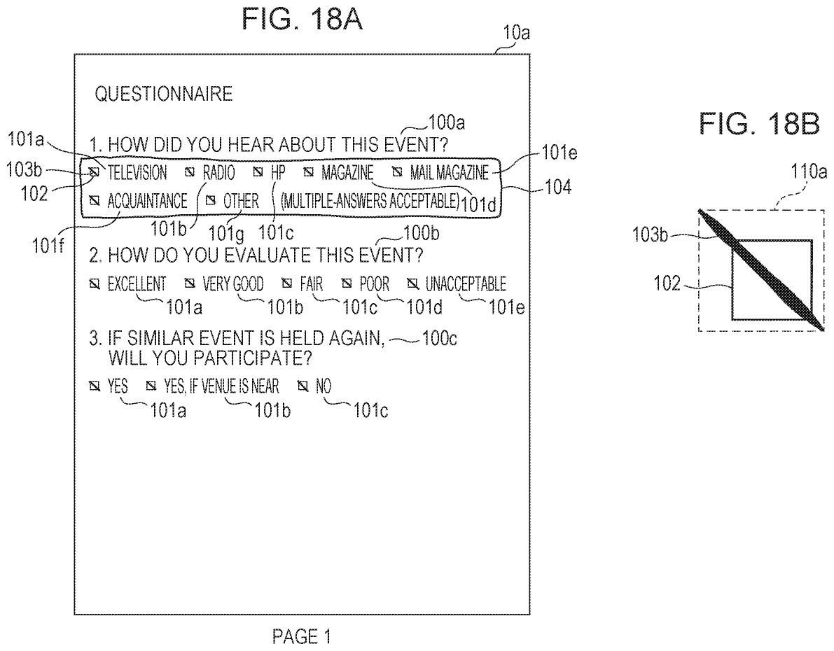

FIG. 18A illustrates an example of the setting questionnaire sheet 10a as page 1 with the first and second regions written thereon. FIG. 18B illustrates a major portion of the setting questionnaire sheet 10a as page 1 with the first region written thereon.

Referring to FIG. 18A, the setting questionnaire sheet 10a includes multiple questions, for example, three questions 100a through 100c. The first question 100a is associated with multiple choices, for example, seven choices 101a through 101g and check boxes 102 to respectively select the choices 101a through 101g. The next question 100b is associated with multiple choices, for example, five choices 101a through 101d and check boxes 102 to respectively select the choices 101a through 101d. The last question 100c is associated with multiple choices, for example, three choices 101a through 101c and check boxes 102 to respectively select the choices 101a through 101c.

The user refers to the guide information in the questionnaire collection guide screen 45 in FIG. 17 and draws a slant line as a first region 103b in a first color (for example, red) marker to indicate the location of the check box 102 in the setting questionnaire sheet 10a as illustrated in FIGS. 18A and 18B. The first region 103b is desirably drawn such that the first region 103b extends across the opposite corners of the check box 102 and protrudes from the opposite corners.

Character string reading “multiple-answers acceptable” is printed at the first question 100a in the setting questionnaire sheet 10a. The question 100a is thus found to be multiple-answers acceptable. The user refers to the questionnaire collection guide screen 45 in FIG. 17 and draws the second region 104 in a second color (for example, blue) marker such that the second region 104 surrounds the choices 101a through 101g to the first question 100a.

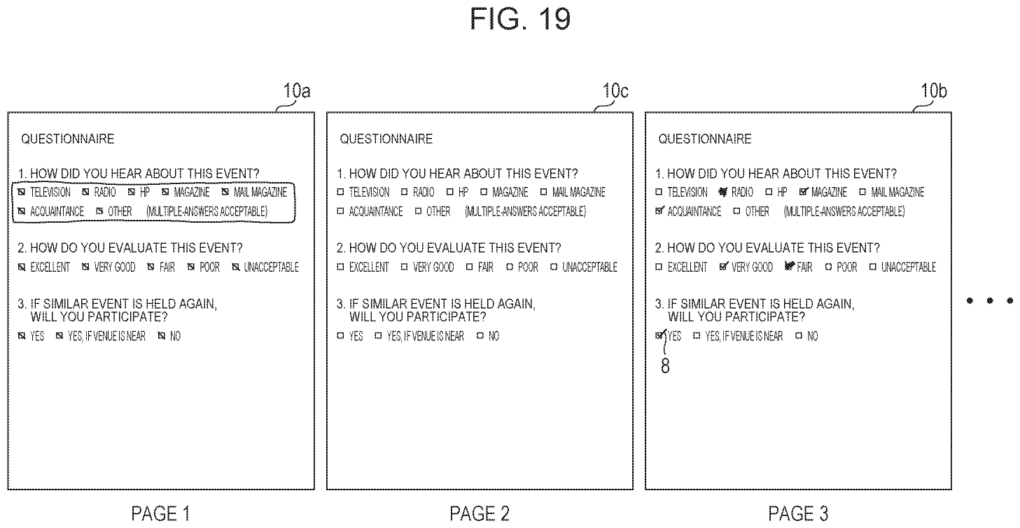

FIG. 19 illustrates an example of a sheet feed order of questionnaire sheets when the questionnaire sheet images are read from the questionnaire sheets. When the setting questionnaire sheet 10a as page 1 is ready, the user refers to the guide information in the questionnaire collection guide screen 45 in FIG. 17. The user stacks questionnaire sheets 10a, 10c, and 10b as illustrated in FIG. 19 such that the setting questionnaire sheet 10a is page 1, original questionnaire sheet 10c is page 2, and answered questionnaire sheet 10b is page 3, and then sets the stack on the automatic sheet feeder in the image reader 5.

The user operates the start button 45f in the guide screen 45 in FIG. 17. The automatic sheet feeder in the image reader 5 successively transports to the read position the set questionnaire sheets 10a, 10c, and 10b in this order.

### (i) Process on Page 1

The scanner in the image reader 5 reads the setting questionnaire sheet image 11a from the setting questionnaire sheet 10a as page 1 transported to the read position by the automatic sheet feeder as illustrated in FIG. 20 (S21). The image reader 5 stores the setting questionnaire sheet image 11a on the memory 3.

The collector 22 detects the red color from the setting questionnaire sheet image 11a to determine whether the first region 103b has been extracted (S22). If the first region 103b is not detected because of a thin red marker or intermittent line markers (no path from S22), the collector 22 displays an error indication on the operation display 4 (S41).

If the first region 103b has been extracted (yes path from S22), the collector 22 attaches a region identification (ID) to the first region 103b and groups the first region 103b (S23).

Specifically, the collector 22 attaches region IDs E1 through E15 to the extracted first regions 103b and records the region IDs at the region ID column in the collection table 31b.

Since the setting questionnaire sheet image 11a includes the second region 105 indicating a multiple-answers acceptable status, the collector 22 attaches the same group ID G1 to the choices 101a through 101g arranged at two rows to the first question 100a. Since the choices 101a through 101e to the next question 100b are arranged in a single row, the collector 22 attaches the same group ID G2 to the choices 101a through 101e. Since the choices 101a through 101c are arranged at a single row to the last question 100c, the collector 22 attaches the same group ID G3 to the choices 101a through 101c. The collector 22 records the group IDs at the group ID column in the collection table 31b. Referring to FIG. 16, the collector 22 records 1 at the flag column to the group ID G1 and the flags at the group IDs G2 and G3 remain at 0.

### (ii) Process on Page 2

The scanner in the image reader 5 reads the original questionnaire sheet image 11c from the original questionnaire sheet 10c as page 2 transported to the read position by the automatic sheet feeder (S24). The image reader 5 stores the questionnaire sheet image 11c on the memory 3.

The collector 22 performs a difference process between the questionnaire sheet image 11a as page 1 and the questionnaire sheet image 11c as page 2, extracts the first region 103b and second region 104, sets the region 110b corresponding to the writing region 110a circumscribing the first region 103b, counts the number of black points within the region 110b in the questionnaire sheet image 11c as page 2, and records the number of black points on page 2 at the number of black points column in the collection table 31b (S25).

(iii) Process on Page 3 and Subsequent Pages

The scanner in the image reader 5 reads the answered questionnaire sheet image 11b in FIG. 21A from the answered questionnaire sheet 10b as page 3 transported to the read position by the automatic sheet feeder (S26). The image reader 5 stores the answered questionnaire sheet image 11b on the memory 3.

The collector 22 counts black points within the region 110b corresponding to the writing region 110a in the answered questionnaire sheet image 11b as page 3 to determine the number of black points and records the number of black points on page 3 at the number of black points column in the collection table 31b as illustrated in FIGS. 16 and 21B (S27).

The collector 22 determines in accordance with the flag in the collection table 31b whether the group having the group ID G1 is multiple-answers acceptable (S28).

The flag at the group ID G1 is 1 and thus indicates that the group ID G1 is multiple-answers acceptable (yes path from S18). From the collection table 31b, the collector 22 reads as the first value the number of black points on page 1 and as the second value the number of black points on page 3 of the group ID G1 (S33), calculates the ratios of the second value to the first value, determines as an answer a ratio of the second value to the first value equal to or above the first threshold and equal to or below the second threshold, and adds 1 to the mark column in the collection table 31b (S34).

The collector 22 determines whether the present group is the last group (S31). If it is determined that the present group is not the last group (no path from S31), the collector 22 proceeds to the next group (S32) to repeat operations in S27 through S30, S33, and S34.

Referring to FIGS. 16 and 21B, 1 is attached to the region IDs E4 and E6 in the group ID G1, 1 is attached to the region ID E9 in the group ID G2, and 1 is attached to the region ID E13 in the group ID G3. The check marks 8 are deleted with the strikeout line 9 in the region IDs E2 and E10 and the number of black points exceeds the second threshold. The collector 22 colors the corresponding cells.

If the collector 22 has determined in step S31 that the present group is the last group (yes path from S31), the collector 22 determines whether the present page is the last page (S35).

Since the present page is page 3 and not the last page (no path from S35), the collector 22 proceeds to step S26 to perform the process performed on page 3 on page 4 and subsequent pages.

The collector 22 counts black points within the region 110b corresponding to the writing region 110a in the answered questionnaire sheet image 11b as page N that is the last page, thus determines the number of black points, and records the number of black points at the number of black points column on page N in the collection table 31b (S27).

If the group is multiple-answers unacceptable (no path from S28), the collector 22 reads as the first value the number of black points on page 1 and as the second value the number of black points on page N in the group ID G2 from the collection table 31b (S39), calculates the ratios of the second value to the first value, determines as an answer a ratio having a maximum ratio in the group ID G2 (the ratio exceeding the second threshold is excluded), and adds 1 to the mark column in the collection table 31b (S30).

The collector 22 determines whether the present group is the last group (S31). If the present group is not the last group (no path from S31), the collector 22 proceeds to the next group (S32) to repeat operations in S26 through S34.

If the present page is the last page (yes path from S35), the collector 22 determines whether a choice having an outlier value with the ratio of the second value to the first value exceeding the second threshold is present (S36). If such a choice is present (yes path from S36), the collector 22 display a verification screen on the operation display 4 (S38).

The verification screen displays a message reading “Are you sure you want to cancel the following choices?” and a message reading “Please correct if necessary”. If the selection is to be corrected (yes path from S39), the correction is to be reflected in the collection table 31b (S40).

In the answered questionnaire sheet image 11b as page 3, the number of black points within the region ID E2 in the group ID G1 is an outlier value of 956 and the number of black points within the region E1 in the group ID G2 is an outlier value of 901. For this reason, the ratio of the second value to the first value exceeds the second threshold. In this case, the collector 22 displays the verification screen for the choices on the operation display 4.

If any choice having the ratio of the second value to the first value exceeding the second threshold is not present (no path from S36) or if the correction is reflected (S40), the collector 22 generates and outputs a writing region setting image 14 in PDF and collection results in CSV (S37). The verification of the outlier and correction in steps S36, and S38 through S40 may be performed after outputting the writing region setting image 14 and collection results.

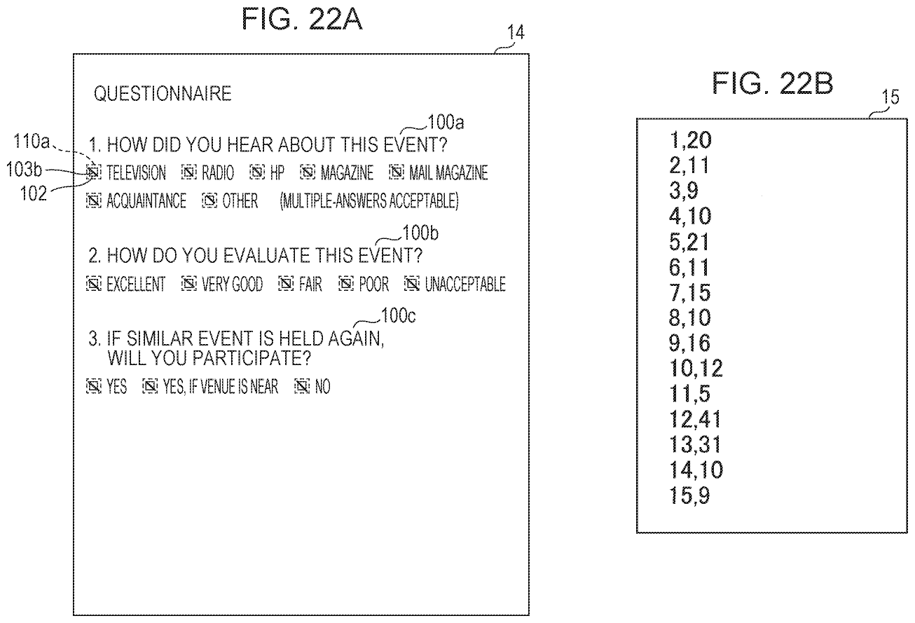

FIG. 22A illustrates an example of the writing region setting image 14 in PDF. The writing region setting image 14 includes the writing region 110a in the setting questionnaire sheet image 11a with the second region 105 removed therefrom. The setting results of the writing region determined on the image forming apparatus 1 via the writing region setting image 14 are verified together with the first region 103b. The writing region setting image 14 may include the second region.

FIG. 22B illustrates an example of the collection results 15 in CSV. The collection results 15 include a leading number indicating the region ID and a subsequent number indicating a mark value. The user may recognize the choice that has the highest mark value through the collection results 15.

### First Modification

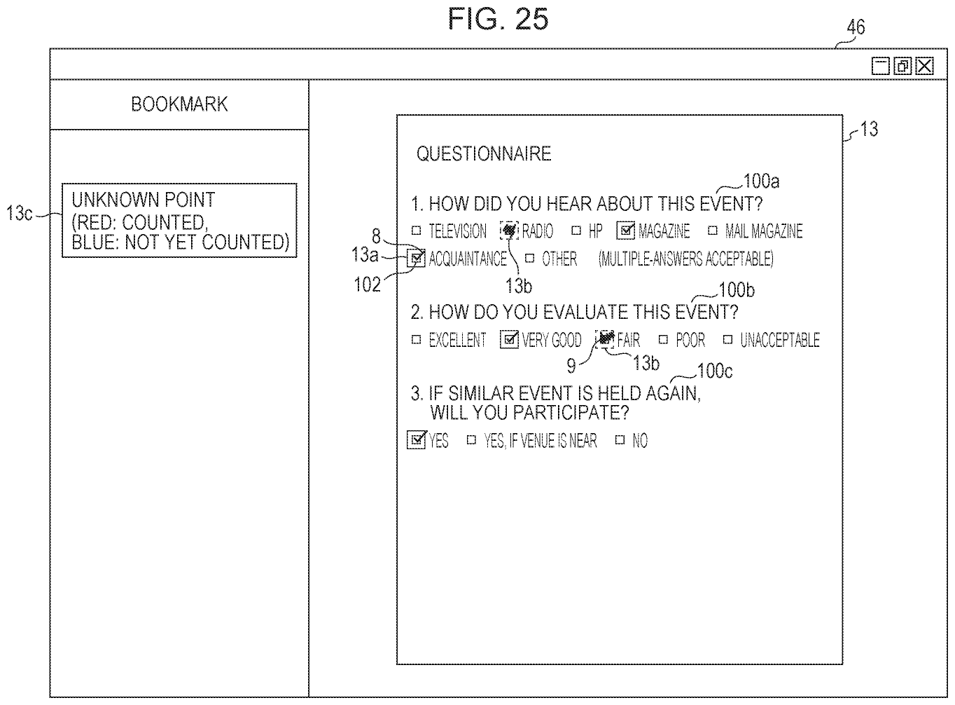

FIG. 25 illustrates a read result screen 46 as a first modification of the second exemplary embodiment. The read result screen 46 is generated by the collector 22 and includes a read result image 13 and a bookmark 13c. The read result image 13 is generated in PDF by adding a red rectangle 13a to the check box 102 indicating the selection result in the answered questionnaire sheet image 11b read from the answered questionnaire sheet 10b as page 3 and by adding a blue rectangle 13b to the check box 102 exceeding the second threshold. The bookmark 13c displays unknown point (red: counted, blue: not counted).

The check mark 8 at the second choice (region ID E2) to the first question 100a is deleted with the strikeout line 9, causing the number of black points to be excessively large. Since the ratio of the second value to the first value exceeds the second threshold, 1 is not added to the mark column. The check mark 8 at the third choice (region ID E10) to the second question 100b is deleted with the strikeout line 9, causing the number of black points to be excessively large. Since the ratio of the second value to the first value exceeds the second threshold, 1 is not added to the mark column.

The selection results determined on the image forming apparatus 1 are confirmed together with the blue rectangle 13b via the read result screen 46. If an outlier value is found in step S16, the verification screen is displayed. In the first modification, the verification screen may not necessarily be displayed.

### Second Modification

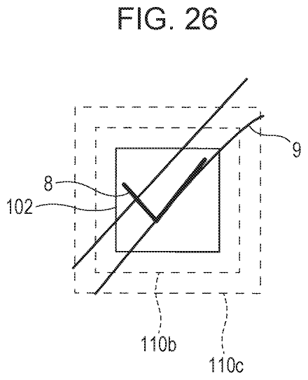

FIG. 26 illustrates a second modification of the first and second exemplary embodiments. A certain region may be set up between the region 110b corresponding to the writing region 110a and a region 110c outside the region 110b and the check mark 8 written in the check box 102 may be deleted with the strikeout lines 9. If the number of black points within the certain region between the regions 110b and 110c exceeds a given threshold, the selection may be excluded from the selection results. The strikeout lines 9 protruded from the check box 102 serve as useful determination criteria.

### Third Modification

According to the exemplary embodiments, the first regions 103a and 103b are written in the setting questionnaire sheet 10a, the setting questionnaire sheet image 11a is read from the setting questionnaire sheet 10a, and the writing region 110a circumscribing the first regions 103a and 103b is set up. Alternatively, the original questionnaire sheet image 11c is read from the original questionnaire sheet 10c without the first regions 103a and 103b written thereon and the writing region 110a may be set up in the original questionnaire sheet image 11c.

### Fourth Modification

According to the exemplary embodiments, the writing region 110a circumscribing the first regions 103a and 103b is set up. Alternatively, a writing region inscribing the first regions 103a and 103b may be set up. If the first region is rectangular, the number of black points within the first region is counted to calculate the first value.

### Fifth Modification

The second region 104 may surround a row of choices forming the same group. Whether the choices form the same group or not may be uniformly determined by referring to the second region 104.

### Sixth Modification

A screen may be displayed to select one of setting methods of the writing regions, including one method that uses the dropout color operation corresponding to the first exemplary embodiment and the other method that uses the difference process performed between the setting questionnaire sheet image and the original questionnaire sheet image.

### Seventh Modification

The colors of the second regions 104 and 105 determine whether the question is multiple-answers acceptable or unacceptable, and also determine the range of the choices falling in the same group. The type and thickness of the line may determine the second region.

The exemplary embodiments have been described. The disclosure is not limited to the exemplary embodiments described above. A variety of modifications are possible. According to the exemplary embodiments, the information processing apparatus is the image forming apparatus. The disclosure may be applied to another information processing apparatus, such as a personal computer (PC).

Part or whole of the processor 2a may be a hardware circuit, such as a field programmable gate array (FPGA) or application specific integrated circuit (ASIC).

In the exemplary embodiments above, the term “processor” refers to hardware in a broad sense. Examples of the processor includes general processors (e.g., CPU: Central Processing Unit), dedicated processors (e.g., GPU: Graphics Processing Unit, ASIC: Application Specific Integrated Circuit, FPGA: Field Programmable Gate Array, and programmable logic device).

In the exemplary embodiments above, the term “processor” is broad enough to encompass one processor or plural processors in collaboration which are located physically apart from each other but may work cooperatively. The order of operations of the processor is not limited to one described in the exemplary embodiments above, and may be changed.

Part of the elements in the exemplary embodiments may be modified or omitted. In the routine of the process of the exemplary embodiments, steps may be added, deleted, modified or interchanged with each other. The program used in the exemplary embodiments may be supplied in a recorded form on a computer readable recording medium, such as a compact disk read-only memory (CD-ROM) or may be supplied from an external server, such as a cloud server, via a network.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising
a processor configured to
acquire a first image read from a sheet with a plurality of first regions that include respectively writing locations of a plurality of choices that are unselected,
acquire a second image read from a sheet with one of the choices selected and with information indicating that the one of the choices has been selected, the information being written at the writing location of the selected choice, and
output a selection result of the selected choice, the selection result determined in accordance with an arithmetic result of an arithmetic operation performed between a first value determined from the first region in the first image and a second value determined from a region in the second image corresponding to the first region, and exclude from the selection result the choice having the arithmetic result having a value equal to or above a specific value.

2. The information processing apparatus according to claim 1, wherein the first image includes a second region that is set to include a plurality of the first regions forming a set, and
wherein the processor is configured to attach, to the second region, identification information indicating whether a set of choices corresponding to the set of the first regions is multiple-answers acceptable or unacceptable.

3. The information processing apparatus according to claim 2, wherein the processor is configured to output, in accordance with the identification information, as the selection result a choice that is determined in accordance with criteria that is different depending on whether the set of the choices is multiple-answers acceptable or unacceptable.

4. The information processing apparatus according to claim 3, wherein the processor is configured to output as the selection result a choice having a maximum arithmetic result among the set of the choices that is multiple-answers unacceptable.

5. The information processing apparatus according to claim 3, wherein the processor is configured to output as the selection result a plurality of choices that are determined by comparing the arithmetic result with a threshold among the set of the choices that is multiple-answers acceptable.

6. The information processing apparatus according to claim 5, wherein the processor is configured to output as the selection result a choice having the arithmetic result equal to or above the threshold and below the specific value.

7. The information processing apparatus according to claim 1, wherein the first regions are set to a first color and the first image includes a second region that is set to the first color or a second color and includes a plurality of the first regions forming a set, and
wherein the processor is configured to output as the selection result a choice that is determined in accordance with a determination as to whether the set in the second region is multiple-answers acceptable, the determination being made depending on whether the color of the second region is the first color or the second color.

8. The information processing apparatus according to claim 1, wherein the first region is set to a first color, and
wherein the processor is configured to extract the first region from the first image in accordance with the first color.

9. The information processing apparatus according to claim 1, wherein the processor is configured to
acquire a third image read from a sheet with the first region not set and the choices unselected, and
extract the first region in accordance with a difference process performed between the first image and the third image.

10. The information processing apparatus according to claim 9, wherein the processor is configured to extract the first region using the third image if using the third image is selected as a method of extracting the first region on a screen.

11. The information processing apparatus according to claim 1, wherein the first value is a number of black points within a writing region corresponding to the first region in the first image and the second value is a number of black points within a region corresponding to the writing region in the second image.

12. The information processing apparatus according to claim 1, wherein the arithmetic result is a ratio of the second value to the first value.

13. The information processing apparatus according to claim 1, wherein the arithmetic result is a difference between the second value and the first value.

14. An information processing apparatus comprising a processor configured to
acquire a first image read from a sheet with a plurality of first regions that include respectively writing locations of a plurality of choices that are unselected,
acquire a second image read from a sheet with one of the choices selected and with information indicating that the one of the choices has been selected, the information being written at the writing location of the selected choice, and
output a selection result of the selected choice, the selection result determined in accordance with an arithmetic result of an arithmetic operation performed between a first value determined from the first region in the first image and a second value determined from a region in the second region corresponding to the first region, and exclude from the selection result the choice having a value that is determined from a region outside a region corresponding to the first region in the second image and is equal to or above a specific value.

15. A non-transitory computer readable medium storing a program causing a computer to execute a process for processing information, the process comprising:
acquiring a first image read from a sheet with a plurality of first regions that include respectively writing locations of a plurality of choices that are unselected;
acquiring a second image read from a sheet with one of the choices selected and with information indicating that the one of the choices has been selected, the information being written at the writing location of the selected choice; and
outputting a selection result of the selected choice, the selection result determined in accordance with an arithmetic result of an arithmetic operation performed between a first value determined from the first region in the first image and a second value determined from a region in the second image corresponding to the first region, and excluding from the selection result the choice having the arithmetic result having a value equal to or above a specific value.
